(19) United States
(12) Patent Application Publication
(10) Pub. No.: US 2009/0167884 A1
(43) Pub. Date: Jul. 2, 2009

(54) Self-Similar Capture Systems

(76) Inventor: Raymond S. Connell Jr., Rancho Palos Verdes, CA (US)

Correspondence Address: PATENT LAW OFFICES OF DAVID MILLERS, 1221 Sun Ridge Road, Placerville, CA, 95667, US

(21) Appl. No.: 12/308,210

(22) PCT Filed: Jun. 8, 2007
(86) PCT No.: PCT/US2007/013517

§ 371 Date: Dec. 8, 2008

Related U.S. Application Data
(63) Continuation-in-part of application No. 11/450,161, filed on Jun. 9, 2006.

(51) Int. Cl. H04N 5/228; G06K 9/00

(52) U.S. Cl. 348/222.1; 382/181; 348/E05.031

(57) ABSTRACT

An image capture system providing self-similar image elements. The self-similar nature of the image elements makes the information taken from an image of an object be invariant with both the magnification and rotation of the object. This can significantly reduce the processing required for object alignment and magnification adjustment during object recognition, identification, verification, or classification processes.

### BACKGROUND

Image recognition is important for a wide variety of applications such as face recognition, fingerprint recognition, image classification, intelligent robotics, and prosthetic human vision. Accordingly, ongoing research is attempting to improve available image recognition methods. Until now, most image recognition methods have been based on extracting feature information from digital image representations using the standard rectangular format. With the standard rectangular format, an image plane 100 as shown in FIG. 1 is divided into a two-dimensional array of uniformly sized rectangular pixels 110, and digital data (e.g., pixel values) are associated with pixels 110 to identify the colors of the pixels in an image. For example, the color of a pixel may be identified by three pixel values indicating RGB color components, or a single pixel value may indicate a color or a grayscale level of the corresponding pixel. Pixels 110 are typically distinguished by X and Y coordinates in the image or array 100, and pixel values are typically stored in one or more arrays and indexed according to their X and Y coordinates in the image. A rectangular image representation of any of the conventional types such as illustrated in FIG. 1 is sometimes referred to herein as an X-Y image.

X-Y images are the standard for digital representations of images and accordingly have been used in image recognition processes. However, X-Y images have disadvantages when used in image recognition processes. In particular, an X-Y image usually contains a large amount of irrelevant information that must be processed in order to extract relevant recognition features. At present, an image with good resolution may contain on the order of a million pixels corresponding to three to four million bytes of pixel values that may need to be processed or manipulated. In particular, for reliable recognition, objects generally must be matched in at least four image parameters or degrees of freedom including position of the image in the X direction, the position of the image in the Y direction, the scale or magnification of the image, and angular orientation or rotations of the object or image. With the large number of pixels involved, performing translations, resealing, and rotations of image data to permit comparison with object data can require a significant amount of processing power, particularly if performed in real time as images are acquired.

Rescaling, in particular, can be a sizable burden when doing on-the-fly object recognition. Conventionally, to compare an image to object data, an object recognition process needs to match the relative sizes of features represented in the image and object data and therefore generally needs to rescale at least some portion of the image or the object data. In some applications, this resealing must be done on-the-fly as the images are captured. For example, when a robot attempts to recognize objects in its environment, each time the robot captures an image of the environment, the robot needs to determine whether that image contains objects that the robot has previously seen. A recognizable object might be small in comparison to the surrounding environment, and the distance to the object will generally vary as the robot moves. Accordingly, the size of an object in the image can commonly differ by a factor of up to 100 or more when compared to the size associated with stored object data. The robot's vision system can accommodate the range of apparent sizes by rescaling each image through a range of scales until the vision system finds a sufficient match to the stored object data or determines that there is no match in the image. Typically, if the image scale differs by more than about 13% from the scale associated with the object data, the probability of a conventional matching technique finding a match drops dramatically. Stepping though a magnification range of 100 in steps of 13% requires about 37 resealing operations, and each resealing operation for even a relatively low resolution image having on the order of 400,000 pixels requires about 1 million or more microprocessor clock cycles. With a reasonable frame rate for captured images, the number of clock cycles just for rescaling can be a significant portion of the processing-time budget of current on-the-fly object recognition systems. Accordingly, more efficient systems and methods for capturing or representing image data are desired.

### SUMMARY

In accordance with an aspect of the invention, a system or method can dramatically reduce the processing burden required for rescaling and/or image reorientation through use of an image representation based on a self-similar tiling of the relevant image area. In a self-similar tiling, pixels correspond to tiles that increase in area with distance from an image center, for example, in the manner of areas of a fixed angular range bounded by successive coils of a logarithmic spiral. Accordingly, a purpose of the invention is to capture images in a self-similar format.

The self-similarity of pixels in an image representation has significant consequences for the extraction of image recognition information. One consequence is that because pixel sizes increase with distance from the center, the number of pixels necessary to produce a unique and recognizable object image covering the full range of potential object sizes can be reduced to about one or two thousand. Also, the image resolution is higher nearer the center of the image where high resolution is generally more important and lower at the outside edges where resolution generally matters less. As a result, identifying details are included along with global identifying information like, for example, an overall shape that would identify an image object as a human face. Another consequence is that object recognition can be achieved independent of object size in an image. Also, with the self-similar pixels being larger as the distance from the center increases, a capture system is potentially less sensitive to X-Y registration than an equivalent X-Y formatted capture system.

In accordance with another aspect of the invention, an image representation can be based on a self-similar spiral tiling, for example, based on a logarithmic spiral. The spiral pattern provides a one-dimensional order or arrangement of pixel values. Using this one-dimensional representation, an image can be rescaled and/or rotated simply by changing an offset of the one-dimensional array or data buffer. As a result, on-the-fly image recognition can be performed using significantly less processing.

### BRIEF DESCRIPTION OF THE DRAWINGS

FIG. 1 illustrates a rectangular or X-Y pixel array used for conventional image representations.

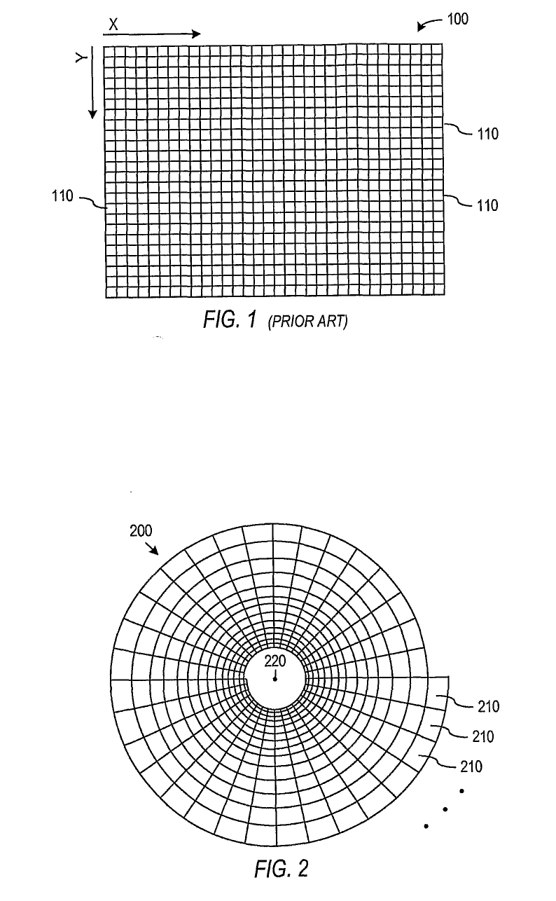

FIG. 2 illustrates a self-similar pixel array using a spiral ordering of pixels for image representations in some embodiments of the present invention.

FIGS. 3A and 3B show images of a face captured with different magnifications by a spiral image capture system in accordance with an embodiment of the invention.

FIGS. 3C and 3D show X-Y images of the same face as in FIGS. 3A and 3B and using approximately the same amount of data as the images of FIGS. 3A and 3B.

FIG. 3E is a graph of the cross-correlation of the data from the images of FIGS. 3A and 3B.

FIG. 4A illustrates a self-similar pixel array using concentric rings to define pixels in an image representation in some embodiments of the present invention.

FIG. 4B illustrates a self-similar pixel array using self-similar square tiling to define pixels in an image representation in some embodiments of the present invention.

FIGS. 5A, 5B, 5C, 5D, and 5E illustrate image capture systems in accordance with alternative embodiments of the present invention.

Use of the same reference symbols in different figures indicates similar or identical items.

### DETAILED DESCRIPTION

In accordance with an aspect of the invention, image representations based on self-similar tilings on images can reduce the burden required for many different image processing.

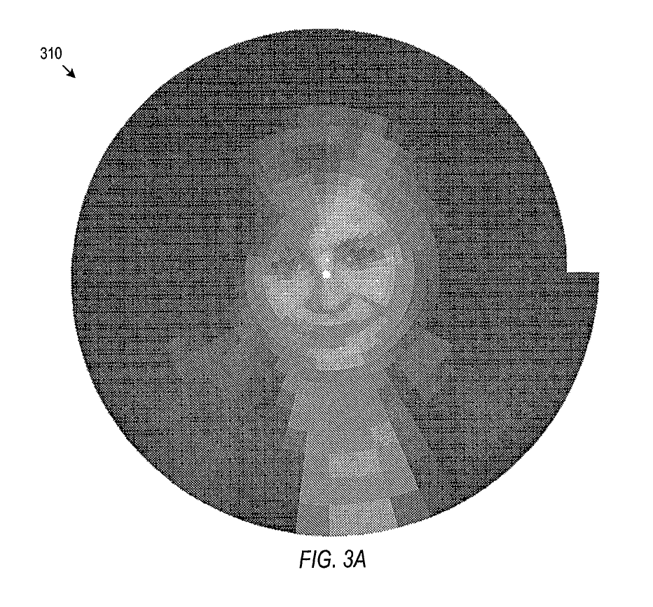

FIG. 2 illustrates a self-similar tiling 200 that covers a portion of an image plane with pixels 210. Each pixel 210 is a picture element or an area of an image, and each pixel 210 can be associated with one or more pixel values indicating a color or grayscale level for the image area corresponding to the pixel 210. Tiling 200 is self-similar in that the pattern of pixels 210 (if infinitely extended) has the same appearance for all magnifications or scales. As illustrated, each pixel 210 has a shape that is similar to the shape of the other pixels 210, and each dimension (e.g., length or width) of each pixel 210 is proportional to a radial distance from a center point 220 of tiling 200. Another property of tiling 200 is that pixels 210 are arranged along a spiral, so that pixel values associated with pixels 210 can be ordered (e.g., along an inward or outward directed spiral) to represent an image using one-dimensional data arrays as opposed to the two-dimensional data arrays used for X-Y images.

Boundaries of pixels 210 in one embodiment of the invention are defined mathematically as being sections of a logarithmic spiral, which is given in Equation 1. In Equation 1, A and B and are constants, and r and θ are polar coordinates with r being a positive radial distance and angle θ being negative or positive. In the illustrated embodiment of tiling 200, each pixel 210 has an inner boundary and an outer boundary corresponding to segments of the logarithmic spiral of Equation 1, where the range of θ for the inner and outer segments differ by 2π. Starting from a sufficiently small radial distance B and θ=0, and proceeding by adding a constant angular increment dθ to θ at each pixel boundary, the sides of each pixel 210 correspond to segments having fixed values of angle θ. With this definition, tiling 200 has the property of scale invariance (if extended to all values of θ), i.e., the tiling looks identically the same at all magnifications or scales.

r=B exp(Aθ) Equation 1

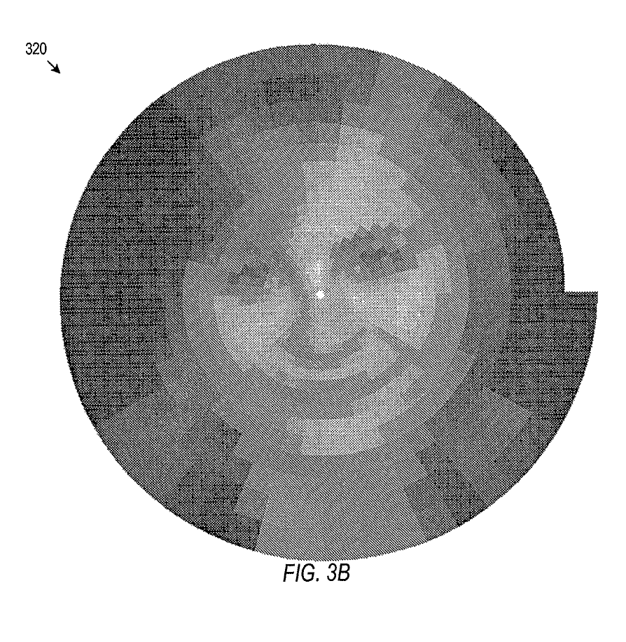

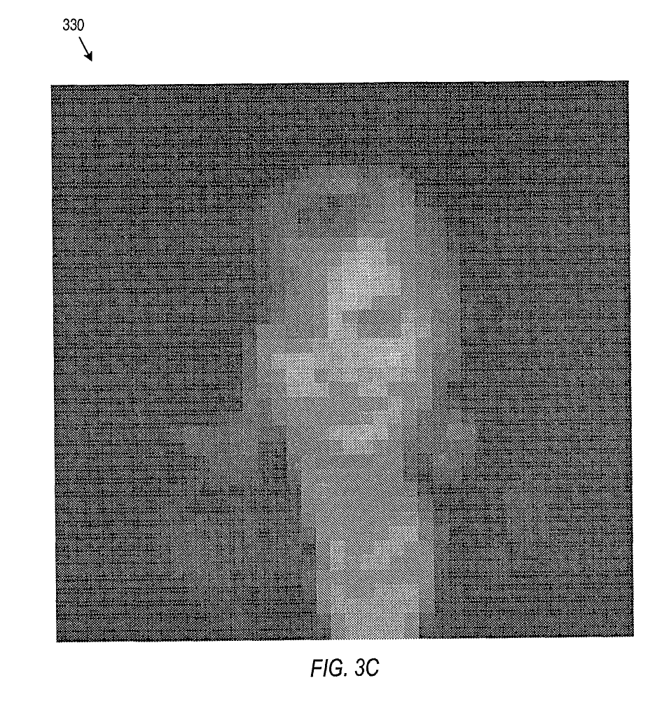

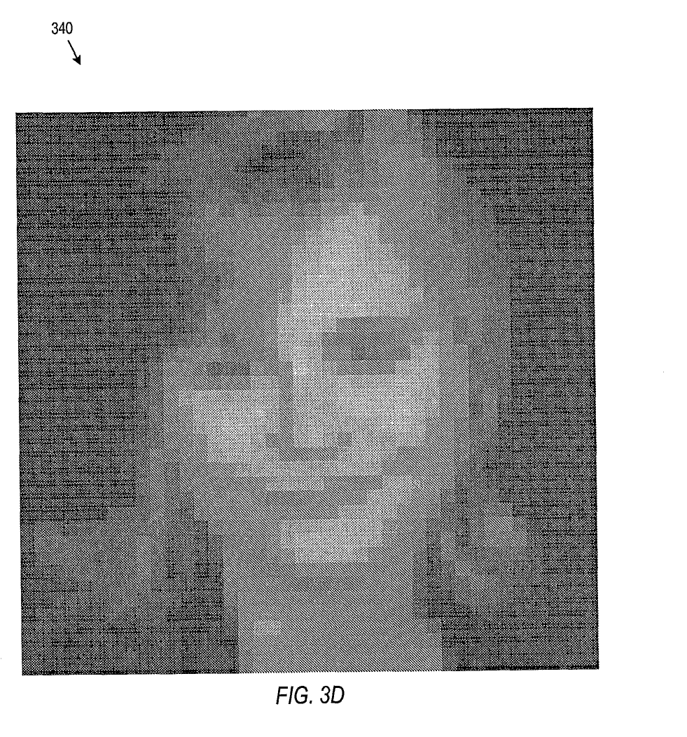

Tiling 200 can provide adequate resolution for recognition processes using fewer pixels than are normally necessary in X-Y representations. Both FIG. 3A and FIG. 3B, for example, illustrate images 310 and 320 that are divided into spiral pixels using a total of 32 spiral rotations with 48 equal-angle spiral cells per rotation. This format produces 1536 pixels 210. By comparison, FIG. 3C and FIG. 3D respectively show X-Y images 330 and 340 of the same face using 1600 pixels, which is more data than used for images 310 and 320 of FIGS. 3A and 3B. Comparing FIGS. 3A and 3B to FIGS. 3C and 3D shows that self-similar tiling 200 preserves facial features better than does an X-Y image using about the same number of pixels.

Pixels 210 can be made approximately rectangular, for example, in a specific configuration of self-similar tiling 200 of FIG. 2 that is based on a logarithmic spiral of Equation 1 with the constant A set to 0.02 radian⁻¹ and angular coordinate 0 incremented by a constant value 2π/48 from one pixel 210 to the next. This embodiment gives each pixel 210 width w (w=2πr/48) proportional to the radial distance r to the pixel. The constant B is the radius of the small blank area in the center of each image 310 and 320 that is not covered by the self-similar tiling assuming that smallest value of angular coordinate θ used is 0. Equation 2 shows that the height h of each pixel, which is the distance between the lower and upper boundaries defined by logarithmic spiral of Equation 1, is also proportional to the radial distance r.

h=r′−r=Be^{A(θ+2π)}−Be^{Aθ}=(e^{2πA}−1)r Equation 2

The examples provided above are not the only possible combinations of angle increment and number of spiral rotations that is effective and, consequently, should be considered as illustrative. The angular increment and the number of spiral rotations for a particular representation can generally be chosen to be any desired values. Besides variation in the angle increment and number of spiral rotations, other variations in spiral tiling 200 are also possible. For example, pixels 210 do not need to be precisely aligned in angle as shown in FIG. 2, instead the number of pixels 210 per spiral rotation can be other than an integer. Further, the boundaries of each pixel 210 do not need to be segments of constant angle α or even to be described by the logarithmic spiral of Equation 1, instead the pixel shapes can be altered and may include gaps (not shown) that are among pixels 210. For example, each pixel 210 may be circular or of any desired regular shape and positioned along a logarithmic spiral. In general, the sizes of the pixels should increase with radial distance to at least approximate a self-similar pattern that appears the same at all magnifications.

The self-similar nature and spiral ordering of pixels 210 makes the information corresponding to an image substantially invariant with either rotation or relative magnification. FIG. 3B, for example, shows an image 320 of the same face as image 310 of FIG. 3A, but image 320 has a higher magnification or was captured at a smaller distance so that the face appears larger in image 320 than in image 310. Magnifying an image effectively moves image content radially outward relative to fixed pixel locations. For some particular magnifications, a magnification maps each pixel to another pixel in the self-similar representation, but more generally, the magnified image content will map to an area including a boundary of pixels. In either case, comparing images 310 and 320 shows that a sequence of pixel values starting with pixels nearest the center of image 310 will be highly correlated with a corresponding sequence of pixel values of image 320 that begins with a pixel further out on the spiral of pixels, that is, at an offset in the one-dimensional sequence of pixel values representing image 320. Rotating an image will similarly cause sequences of pixel values of a spiral self-similar representation of the original image to be highly correlated with a sequence of pixel values of a spiral self-similar representation of the rotated image.

FIG. 3E shows a graph of a cross-correlation as a function of a relative offset between grayscale pixel values in a spiral self-similar representation of image 310 of FIG. 3A and grayscale pixel values in a spiral self-similar representation of image 320 of FIG. 3B. To demonstrate the invariance of image object information with object size, spatial derivatives of the data arrays for the two spiral face images in FIGS. 3A and 3B were cross-correlated. Symmetric first differences dfᵢ for each image cell array f at element i were generated as dfᵢ=(fᵢ₋₁+fᵢ₊₁)/2. The graph of FIG. 3E oscillates as a result of peak correlations appearing at offsets corresponding to matching image orientations, and the overall peak in the graph corresponds to an offset when both image magnification and orientation match. With normalization to the autocorrelation maximum of FIG. 3A, the cross-correlation in FIG. 3E is smaller by about 0.014734. The main source of this error is a small amount of missing scan in image 310 of FIG. 3A within the white blank area in the center of the image that is included around the central blank area of image 320 of FIG. 3B.

Different object sizes/magnifications or rotations of an object thus effectively translate the data or pixel values along the length of the spiral in a spiral self-similar representation. As a result, an object recognition process using a spiral self-similar representation would not need to rescale or rotate image data or comparison data even when the image data and comparison data correspond to different magnifications or different orientations. A match can be found simply by finding a sequence of image data that is highly correlated to the comparison data sequence.

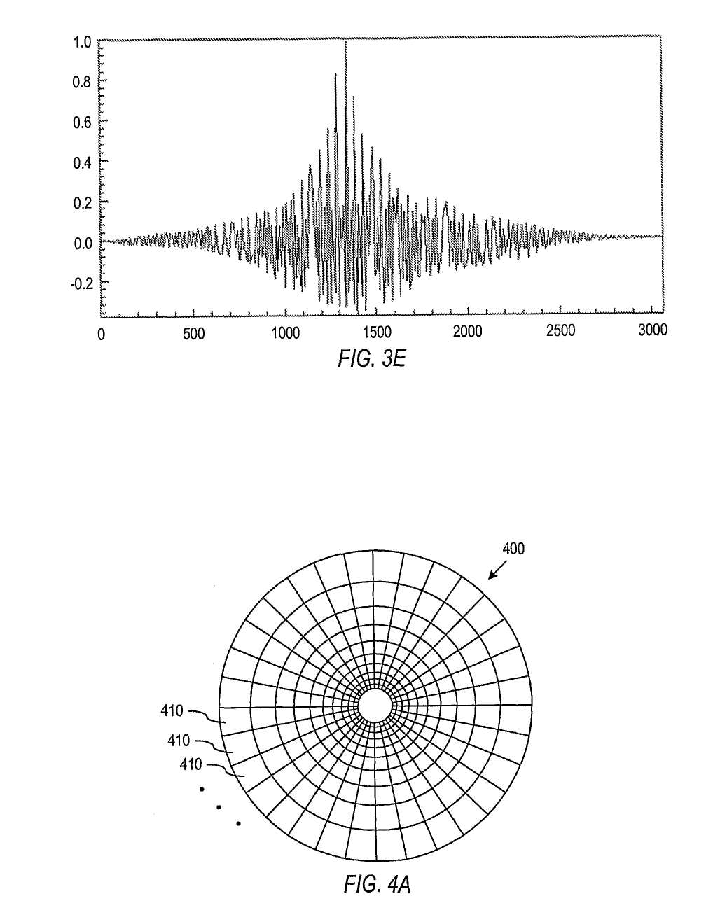

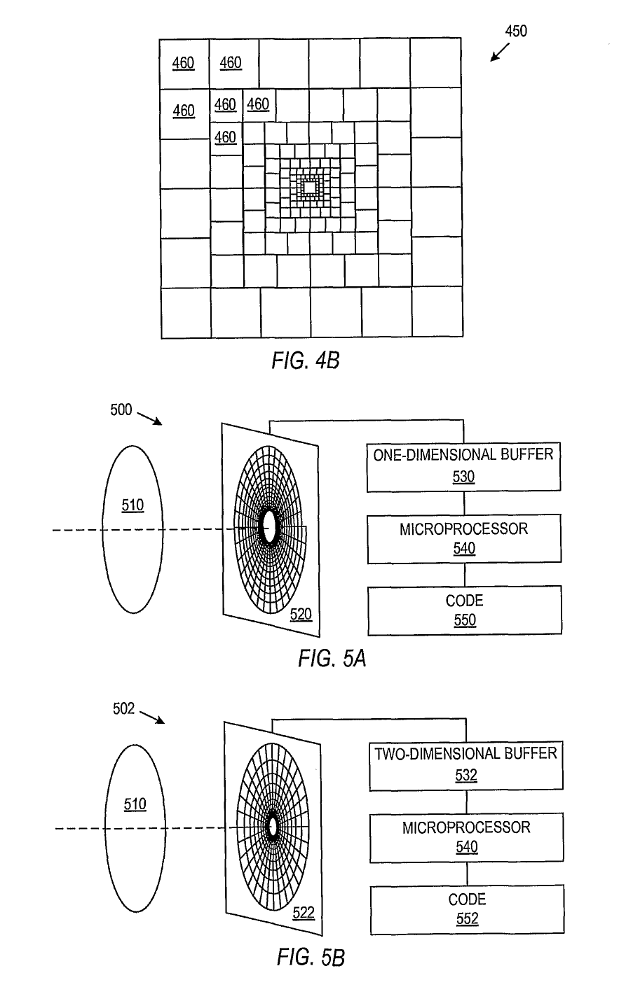

Image representations based on the spiral self-similar tiling 200 of FIG. 2 have significant benefits for processes such as object recognition. However, similar benefits can be achieved using other self-similar tilings as the basis of an image representation. FIG. 4A, for example, illustrates a self-similar tiling 400 made up of pixels 410 that are arranged in a series of circular concentric rings. In an exemplary embodiment of tiling 400, each pixel 410 has an inner boundary with a radius of curvature rₙ and an outer boundary with a radius of curvature rₙ₊₁, where radii rₙ and rₙ₊₁ satisfy Equation 3. In Equation 3, C is a constant greater than 1. The sides of each pixel 410 correspond to segments having fixed values of angular coordinate θ. With this definition, tiling 400 (if extended infinitely to all positive and negative values of index n) looks identically the same at all magnifications or scales, i.e., tiling 400 is self-similar.

rₙ₊₁=Crₙ Equation 3

Images centered on an object and represented using pixels 410 may be identified as matching simply by finding a high cross-correlation of pixel values in a concentric ring of an image with pixel values in a ring associated with comparison data, even when the images have different magnifications of the object and different object orientations. A disadvantage of an image representation based on tiling 400 of FIG. 4A when compared to an image representation based on tiling 200 of FIG. 2 is that the tiling 400 does not provide a natural one-dimensional ordering of pixel values.

Tiling 400 can be varied from the specific example illustrated in FIG. 4A. In particular, the number of concentric rings of pixels and the number of pixels per ring can be any desired values, and the angular ranges defining pixels 410 in different rings may be shifted relative to each other. Additionally, the shape of pixels 410 can be altered and may, for example, create gaps in an image that are not covered by any pixels 410. Further, the shape of the rings as well as the shape of the pixels can be varied. FIG. 4B, for example, shows a self-similar tiling 450 based on square pixels 460 arranged in concentric squares. Other self-similar tilings can be constructed based on other polygons or on irregular shapes. Accordingly, the specific self-similar tilings in the drawings are intended here to illustrate examples of self-similar tilings, but embodiments of the invention can employ other types of self-similar tilings to provide similar benefits.

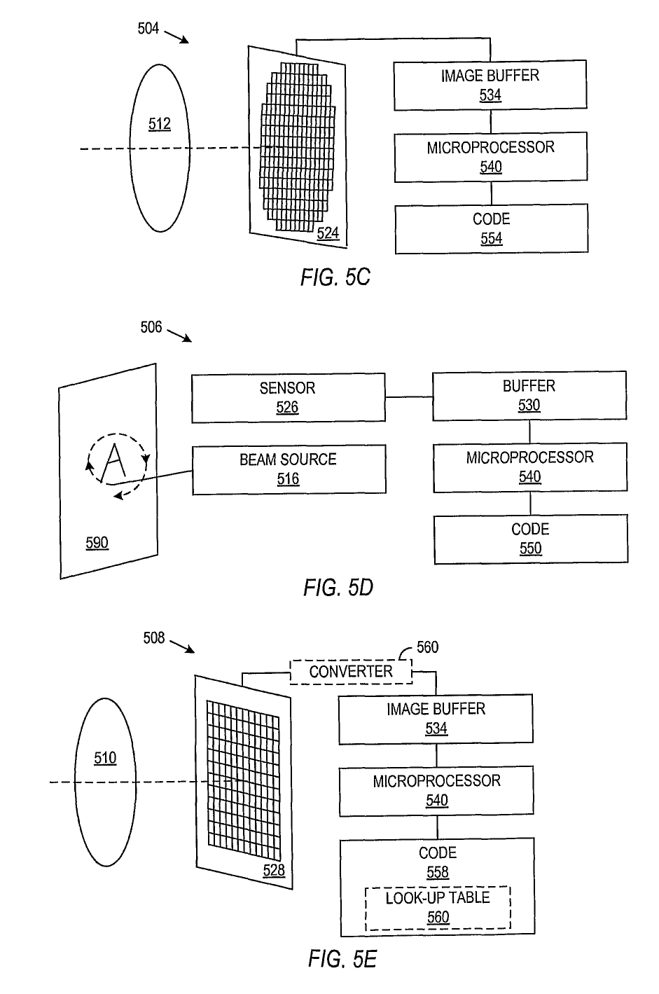

FIGS. 5A, 5B, 5C, 5D, and 5E illustrate some image capture systems in accordance with embodiments of the invention that produce image data based on a self-similar tiling. FIG. 5A, for example, shows an image capture system 500 in which a lens system 510 projects an image on a detector array 520 having pixel sensors arranged according to tiling 200 of FIG. 2. Lens system 510 can be of any type suitable for a conventional digital camera and detector array 520 can be an integrated circuit containing pixel sensors of a conventional circuit design. Such pixel sensors are well known and may be manufactured, for example, using charge coupled devices (CCDs) or CMOS technology. Detector array 520 differs from conventional image sensors in that the light sensitive areas of the pixel sensors in array 520 are arranged on a spiral (e.g., a logarithmic spiral defined in Equation 1) and have areas that increase in proportion to the square of a radial distance from a center of array 520. Additionally, the pixel sensors have an order according to the spiral arrangement, so that values captured by pixels sensors of detector array 520 can be stored in a one-dimensional image buffer 530. Typically, a single one-dimensional image buffer 530 is sufficient for grayscale data, but multiple one-dimensional buffers may be employed for separate color components representing a color image. A processor 540 can execute software, firmware, or other code 550 to process the image data from buffer 530 in any desired manner, for example, for an image recognition process.

FIG. 5B illustrates an image capture system 502 in accordance with an embodiment of the invention generating an image representation based on the self-similar tiling 400 of FIG. 4A. System 502 includes a lens system 510 that projects an image on a detector array 522. Detector array 522 can use the same technology as detector array 520 of FIG. 5A, but light sensitive areas for detector array 522 are arranged in concentric rings. Again the areas of the light sensitive areas of the pixel sensors in detector array 522 increase in proportion to the square of the distance from the center of detector array 522. For the self-similar tiling of system 502, a two-dimensional image buffer 532 may be preferred with each concentric ring of pixel sensors in detector array 522 corresponding to a different row (or column) of two-dimensional image buffer 532. Code 552 executed by microprocessor 540 in system 502 for processing of a concentric self-similar image representation may accordingly differ from code 550 for processing of a spiral self-similar image representation.

FIG. 5C illustrates an image capture system 504 in accordance with an embodiment of the invention that uses intentional distortion in a lens system 512 to allow use of a detector array 524 having pixel sensors that are uniformly sized or at least more uniformly sized than the pixel sensors in detector arrays 520 and 522. Lens system 512 in particular may provide at least some amount of barrel distortion in the image formed on detector array 524. Barrel distortion is such that magnification across the image varies with the radial distance from the optical axis of lens system 512 or the image center on detector 524. This effect may be used by itself or in combination with variation in pixel sensor sizes to provide a desired self-similar representation of the image. The pixel sensors in detector array 524 may be arranged in spiral or concentric rings to provide either a spiral or concentric self-similar representation of the image. Code 554 for microprocessor 540 can be adapted according to the representation that system 504 provides.

FIG. 5D illustrates an image capture system 506 that acts a scanner to capture a self-similar representation of an image. System 506 includes a beam source 516 that projects a beam onto an object 590, and a sensor 526 is positioned to sense the beam intensity reflected from object 590. To generate a self-similar representation, beam source 516 can scan the beam along a spiral path on object 490 while increasing the diameter of the beam in proportion to a radial distance from a center of the area of object 590 being scanned. As a result, intensity data periodically captured by sensor 526 will indicate average reflectivity of areas of increasing size as the scanning progresses. The scanned data can be stored in a one-dimensional buffer 530 and processed by a processor 540 executing code 550 in the same manner as the embodiment of the invention described with reference to FIG. 5A.

While it is desirable to capture image data directly from an image source that arranges pixels according to a self-similar tiling, self-similar image representations can also be generated from still frame or video cameras or from any digital images that provide data consisting of pixels of uniform size arranged in a two-dimensional or X-Y array. FIG. 5E illustrates an image capture system 508 including a lens system 510 and a detector array 528 with pixel sensors in a two-dimensional rectangular array. Lens system 510 and detector array 528 may, for example, be components in a conventional digital video camera. In such cases, the X-Y pixels can be mapped to virtual spiral or concentric pixels. In one configuration of system 508, a converter 560 can implement a hardware conversion of X-Y pixel data to spiral or concentric pixel data. In an alternative configuration, microprocessor 540 executes code 558 to convert or re-map X-Y pixel data to the desired data for a self-similar representation.

Efficient image re-mapping can employ a lookup table 560 in X-Y format that contains the indexes of self-similar pixels that would overlay the X-Y pixels. Execution of code 558 can use the X-Y position of every X-Y pixel in the input image as an index into the lookup table data array taking into account possible offset in X-Y position of the center of a self-similar tiling. When a particular pixel position indexes a lookup table location containing the index of a specific self-similar pixel, the color bytes of that X-Y pixel are averaged into the color bytes of the self-similar pixels at the index location. Converter 560 can implement the conversion of X-Y pixel data as the data signals from detector array 528 are provided, so that self-similar pixel values are stored in buffer 534. Alternatively, X-Y pixel values from detector 528 can be stored in buffer 534, and microprocessor 540 can execute code 558 using look-up table 560 to convert the X-Y pixel values to values corresponding to pixels in the desired self-similar representation.

In one specific embodiment, lens 510 and detector 528 are components of a conventional digital camera, and converter 560 is implemented in code 558 that a general purpose computer system such as a personal computer executes. In this particular embodiment, processor 540 can be the processor of the general purpose computer system, and image buffer 534 and code 558 may be in memory or other computer readable media that is accessible to microprocessor 540.

Lookup table 560 could be constructed in memory by first selecting enough empty memory to enclose an image of the self-similar tiling (e.g., tiling 200, 400, or 450 of FIGS. 2, 4A, or 4B) on the X-Y format. Lookup table 560 can then be filled by indexing through that memory and determining, e.g., by the use of the equations above, which self-similar pixel index, if any, is to be placed in the X-Y table location. That index or a marker value for none would then be inserted into the X-Y location in table 560.

FIGS. 5A to 5E illustrate examples of imaging systems in accordance with a few embodiments of the invention. However, many other existing systems and methods could potentially obtain data corresponding to a self-similar representation of an image and could therefore be incorporated in alternative embodiments of the invention. Embodiments of the invention thus include but are not limited to the use of mechanical and electronic image scanners, direct imaging devices, and devices that re-map image formats.

Although the invention has been described with reference to particular embodiments, the description is only an example of the invention's application and should not be taken as a limitation. Various adaptations and combinations of features of the embodiments disclosed are within the scope of the invention as defined by the following claims.

What is claimed is:

1. A system comprising:
a generator of image cell values that respectively correspond to areas that are arranged substantially along a spiral in an image, each of the image cell values indicating a characteristic of the corresponding area in the image; and
a memory connected to store the image cell values in a one-dimensional sequence.

2. The system of claim 1, wherein the image cells have areas that increase with distance from a center of the spiral.

3. The system of claim 1, wherein each of the image cells corresponds to an area in the image that is bounded by two segments of a logarithmic spiral and two segments of lines extending radially from a center of the spiral.

4. The system of claim 1, wherein the generator comprises an integrated circuit containing light sensitive elements arranged substantially along the spiral.

5. The system of claim 1, wherein the generator comprises an image scanner that scans along a path that is substantially the spiral.

6. The system of claim 1 wherein the generator comprises a computer readable medium containing code that when executed by a computer, re-maps a set of pixel values associated with an X-Y representation of the image into the image cell values.

7. The system of claim 1 wherein the generator comprises an integrated circuit that converts a set of pixel values associated with an X-Y representation of the image into the image cell values.

8. A system comprising:
a generator of image cell values, wherein the image cell values correspond to a plurality of areas that provide a self-similar tiling of an image and respectively indicating a characteristic of the areas in the image; and
a multi-element data register connected to store the image cell values.

9. The system of claim 8, wherein each of the areas has a first dimension that is proportional to a distance of the area from a center of the image.

10. The system of claim 9, wherein the first dimensions of the areas are widths, and each of the areas has a length that is proportional to the distance of the area from the center of the image.

11. The system of claim 8, wherein the areas are arranged along a logarithmic spiral.

12. The system of claim 8, wherein the areas are arranged along a series of concentric rings.

13. A system comprising:
a camera capable of producing an X-Y representation of an image; and
a converter coupled to the camera, wherein the converter converts the X-Y representation of the image into a representation of the image having pixels corresponding to a self-similar tiling of the image.

14. The system of claim 13, wherein the pixels corresponding to the self-similar tiling are arranged along a spiral in the image.

15. The system of claim 13, wherein the each pixel corresponding to the self-similar tiling is bounded by successive segments of a logarithmic spiral.

16. The system of claim 13, wherein the pixels corresponding to the self-similar tiling are arranged in a plurality of rings in the image.

17. The system of claim 13, wherein areas of the pixels corresponding to the self-similar tiling are proportional to a square of a radial distance from a center of the self-similar tiling.
